(19) United States
(12) Patent Application Publication
(10) Pub. No.: US 2024/0163899 A1
(43) Pub. Date: May 16, 2024

(54) USER EQUIPMENT PERFORMING BLIND DECODING AND OPERATING METHOD THEREOF

(71) Applicant: SAMSUNG ELECTRONICS CO., LTD., SUWON-SI (KR)

(72) Inventors: Juhyuk Im, Suwon-si (KR); Daeson Kim, Suwon-si (KR)

(21) Appl. No.: 18/502,232

(22) Filed: Nov. 6, 2023

(30) Foreign Application Priority Data
Nov. 14, 2022 (KR) 10-2022-0151998
Feb. 15, 2023 (KR) 10-2023-0020124

(51) Int. Cl. H04W 72/232; H04L 1/00; H04W 76/20

(52) U.S. Cl. CPC H04W 72/232; H04L 1/0038; H04W 76/20

(57) ABSTRACT

Provided are a user equipment performing a blind decoding operation, and an operating method of the user equipment. An operating method of a user equipment includes receiving a physical downlink control channel (PDCCH) including a plurality of control channel elements (CCEs) corresponding to one control resource set (e.g. a CORESET), determining a division value corresponding to a number of CCEs to be included in at least a first group of N groups of CCEs based on PDCCH configuration-related information, dividing the plurality of CCEs into the N groups based on the division value, performing CCE to resource element (RE) demapping on the first group, and decoding the demapped first group.

### CROSS-REFERENCE TO RELATED APPLICATIONS

This application is based on and claims priority under 35 U.S.C. § 119 to Korean Patent Application Nos. 10-2022-0151998 and 10-2023-0020124, respectively filed on Nov. 14, 2022 and Feb. 15, 2023, in the Korean Intellectual Property Office, the disclosures of which are incorporated by reference herein in their entireties.

### TECHNICAL FIELD

This disclosure relates generally to wireless communication, and more particularly, to user equipment (UE) that performs blind decoding, and an operating method of the UE.

### DISCUSSION OF RELATED ART

To support transmission of downlink and uplink transmission channels in a communication system, downlink control information (DCI) related thereto is required in today's protocols. A UE may receive a physical downlink control channel (PDCCH) from a base station, decode the PDCCH, and receive DCI based on a decoding result.

The PDCCH may have various formats, but the UE may not know a format selected by the base station in advance. In addition, because time/frequency resources defined as a search space may be transmitted through an arbitrary resource in a set, an exact time/frequency resource through which the PDCCH is transmitted is not known to the UE beforehand. Accordingly, the UE performs decoding on the PDCCH based on blind decoding.

With blind decoding, the UE performs decoding (i.e., attempts decoding, which may or may not be successful) on a plurality of PDCCH candidates, each including at least one control channel element (CCE), in a plurality of search spaces. When a cyclic redundancy check (CRC) passes in a process of decoding any one of the plurality of PDCCH candidates, the UE may determine that DCI included in the corresponding PDCCH candidate is valid (decoding is successful) and may process scheduling assignment, scheduling grant, and the like included in the corresponding DCI.

However, in order to parse one unit of DCI in accordance with some communication standards or proposals (e.g., next-generation (5G) communication), it is necessary to identify configurations of CCEs of all candidates of a plurality of search spaces and perform blind decoding with respect to all of the search spaces. As a result, the processing time and memory size required for blind decoding in the UE are considerable, thereby limiting the performance of the UE.

### SUMMARY

Embodiments of the inventive concept provide a user equipment (UE) in which a time and memory space required for blind decoding are reduced relative to conventional methods, by dividing control channel elements (CCEs) of a search space into CCE groups and performing blind decoding in units of the CCE groups. Blind decoding processing time and memory space may also be reduced in embodiments by performing demapping (of CCE to resource elements (REs)) and decoding of demapped CCEs in parallel. Additionally, a control resource set may be a CORESET. Additionally, CCE to RE demapping on a first group may comprise a demapping of each CCE of a first group to at least one RE group (REG).

According to an aspect of the inventive concept, an operating method of a user equipment includes receiving a physical downlink control channel (PDCCH) including a plurality of control channel elements (CCEs) corresponding to one control resource set (e.g., a CORESET), determining a division value corresponding to a number of CCEs to be included in at least a first group of a plurality N of groups of CCEs, based on PDCCH configuration-related information, dividing the plurality of CCEs into the N groups based on the division value, performing CCE to resource element (RE) demapping on the first group, and decoding the demapped first group.

According to another aspect of the inventive concept, an operating method of a user equipment for performing blind decoding includes receiving a PDCCH including a plurality of CCEs corresponding to one control resource set and PDCCH configuration-related information, determining a division value corresponding to a number of CCEs to be included in each of a plurality of groups of CCEs based on the PDCCH configuration-related information, dividing the plurality of CCEs into first to N^{th} (N is a natural number of 2 or more) groups based on the division value, performing demapping on the first group, and performing blind decoding on the demapped first group and demapping on the second group in parallel.

According to another aspect of the inventive concept, a user equipment includes a radio frequency (RF) integrated circuit configured to receive, from a base station, a PDCCH including a plurality of CCEs and PDCCH configuration-related information, and a processing circuit configured to determine a division value based on the PDCCH configuration-related information, divide the plurality of CCEs into a plurality of groups based on the division value, sequentially perform demapping operations on the plurality of groups on a group by group basis, and perform decoding operations on the plurality of groups on a group by group basis in an order in which demapping operations are completed.

### BRIEF DESCRIPTION OF THE DRAWINGS

Embodiments will be more clearly understood from the following detailed description taken in conjunction with the accompanying drawings in which:

FIG. 1 is a block diagram illustrating a wireless communication system, according to an embodiment;

FIG. 2A is a diagram illustrating a basic structure of a time-frequency domain that is a wireless resource region in a wireless communication system, according to an embodiment;

FIG. 2B is a diagram illustrating a physical downlink control channel (PDCCH) and an enhanced PDCCH (EPDCCH) in a wireless communication system supporting long term evolution (LTE), according to an embodiment;

FIG. 2C is a diagram illustrating a CORESET in which a PDCCH is transmitted in a wireless communication system supporting new radio (NR); FIG. 2D is a diagram illustrating a basic unit of time and frequency resources constituting a PDCCH in a wireless communication system supporting NR, according to an embodiment;

FIG. 3 is a block diagram illustrating a user equipment (UE), according to an embodiment;

FIG. 4 is a diagram for describing an operation of determining a division value based on an aggregation level of a UE, according to an embodiment;

FIGS. 5A and 5B are diagrams for describing a demapping operation of a UE, according to an embodiment;

FIG. 6 is a flowchart illustrating an operating method of a UE, according to an embodiment;

FIG. 7 is a flowchart illustrating an operating method of a UE, according to an embodiment;

FIG. 8 is a graph showing a time required for a demapping operation and a decoding operation of a UE according to Comparative Example and a time required for a demapping operation and a decoding operation of a UE according to Embodiment;

FIG. 9 is a block diagram illustrating an electronic device, according to an embodiment; and

FIG. 10 is a conceptual diagram illustrating an Internet of things (IoT) network system to which an embodiment is applied.

### DETAILED DESCRIPTION OF EMBODIMENTS

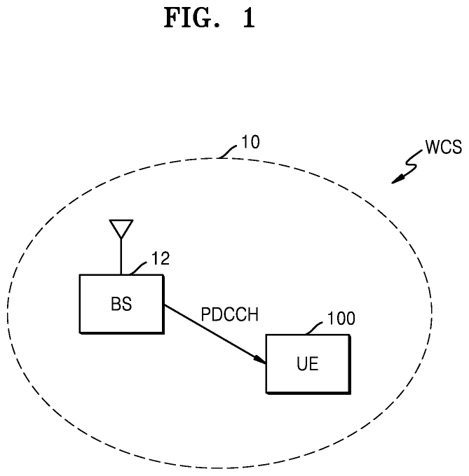

FIG. 1 is a block diagram illustrating a wireless communication system, according to an embodiment.

Hereinafter, embodiments of the inventive concept are described based on a new radio (NR) network-based wireless communication system WCS, in particular, the Third Generation Partnership Project (3GPP) Release 17, but the technical idea of the inventive concept is not limited to the NR network. The technical idea of the inventive concept may be applied to other wireless communication systems having a similar technical background or channel configuration, for example, long term evolution (LTE), LTE-advanced (LTE-A), wireless broadband (WiBro), global system for mobile communication (GSM), cellular communication systems, such as next-generation communication, such as 6G, or short-distance communication systems, such as Bluetooth and near field communication (NFC).

Referring to FIG. 1, a wireless communication system WCS may include a base station 12 and a user equipment (UE) 100. The base station (interchangeably, “cell”) 12 may generally refer to a fixed station that communicates with the UE 100 and/or other base stations (not shown), and may exchange control information and data by communicating with the UE 100 and/or other cells (not shown). For example, the base station 12 may be referred to as a Node B, an evolved-Node B (eNB), a next generation Node B (gNB), a sector, a site, a base transceiver system (BTS), an access point (AP), a relay node, a remote radio head (RRH), a radio unit (RU), a small cell, a wireless device, or the like.

The UE 100 may be fixed or mobile, and may refer to any device capable of communicating with the base station 12 to transmit and receive data and/or control information. For example, the UE 100 may be referred to as a terminal, terminal equipment, a mobile station (MS), a mobile terminal (MT), a user terminal (UT), a subscriber station (SS), a wireless device, a handheld device, or the like.

The base station 12 may transmit a physical downlink control channel (PDCCH) including downlink control information (DCI) to the UE 100 in order to provide the DCI to the UE 100. The base station 12 may set at least one control resource set, hereafter exemplified as a CORESET, in a frequency band for communication with the UE 100. The frequency band in which the CORESET is set may correspond to a single cell (or a single serving cell). A CORESET refers to a resource set in a time-frequency domain that enables the UE 100 to perform blind decoding on PDCCH candidates in a search space. In some embodiments, a plurality of search spaces may exist in a plurality of CORESETs, and at least one PDCCH candidate may exist in one search space. In some embodiments, a PDCCH may include a plurality of control channel elements (CCEs) corresponding to one CORESET. A CCE may be a basic information unit for receiving a PDCCH, and may include a plurality of log likelihood ratios (LLRs). For example, in an NR network, one CCE may include 108 LLRs, and in LTE, one CCE may include 72 LLRs.

The base station 12 may provide wireless broadband access to the UE 100 within its coverage 10. The base station 12 may perform scheduling for transmitting PDCCH configuration-related information to the UE 100 within its coverage 10. In some embodiments, the base station 12 may allocate resources in a time-frequency domain to transmit the PDCCH configuration-related information to the UE 100. For example, the base station 12 may schedule to transmit the PDCCH configuration-related information to the UE 100 in a duration for radio resource control (RRC) signaling with the UE 100. For example, the base station 12 may schedule to transmit the PDCCH configuration-related information to the UE 100 in an arbitrary duration after RRC connection with the UE 100.

The UE 100 may receive the PDCCH configuration-related information from the base station 12. The PDCCH configuration-related information may include aggregation levels of CCEs included in the PDCCH, the number of PDCCH candidates, and the number of CCEs allocated to each PDCCH. An aggregation level may be a value indicating how many CCEs are included in one PDCCH candidate. The number of possible PDCCH candidates for each aggregation level may be defined in Table 1.

TABLE 1

| Aggregation | The number of PDCCH | The number of PDCCH |
|---|---|---|
| level | candidates in NR network | candidates in LTE |
| 1 | 8 | 6 |
| 2 | 8 | 6 |
| 4 | 8 | 4 |
| 8 | 8 | 2 |
| 16 | 4 | X |

In some embodiments, when the UE 100 receives the PDCCH configuration-related information and an aggregation level of the PDCCH and a maximum number of PDCCH candidates are determined, the wireless communication system WCS may determine a “start CCE” through an equation described in the 3GPP Release 17 based on the PDCCH configuration-related information. The start CCE may refer to a first CCE of a first PDCCH candidate from among CCEs allocated to the PDCCH included in the PDCCH configuration-related information. The wireless communication system WCS may determine the number of CCEs corresponding to the aggregation level as one PDCCH candidate based on the start CCE and may determine a data carrying area for all PDCCH candidates. For example, the wireless communication system WCS may determine the start CCE, CCE_{ST}, in the NR network by applying Equation 1.

$${CCE}_{ST} = L \cdot \{ ( \text{?} + ⌊ \frac{\text{?} \cdot {N}_{CCE , p}}{L \cdot {M}_{s , max}^{( L )}} ⌋ + \text{?} ) mod ⌊ \text{?} / L ⌋ \} + i \qquad [ Equation 1 ]$$

$$\text{?} \text{indicates text missing or illegible when filed}$$

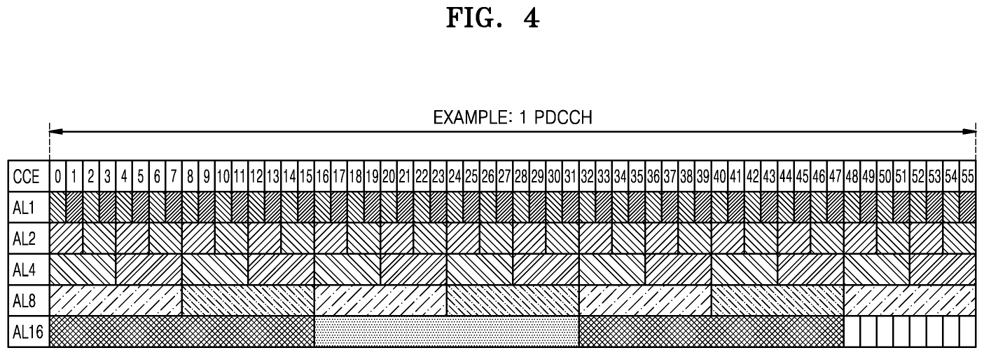

In eqn. 1, L may denote an aggregation level, m_{s,n}_{_{CI}} may denote a PDCCH candidate, and N_{CCE,p} may denote the number of CCEs corresponding to one CORESET. i may denote a natural number from 0 to L-1, and Y_{p,n}_{_{ƒ}}_{^{μ}} and M_{s,max}^{(L)} may denote parameters used to determine a start CCE. Because the aggregation level L is calculated as outermost multiplication, start CCEs of all PDCCH candidates may exist as multiples of the aggregation level L. Some embodiments of determining a start CCE by applying Equation 1 and determining a PDCCH candidate based on the determined start CCE will be described below with reference to FIG. 4.

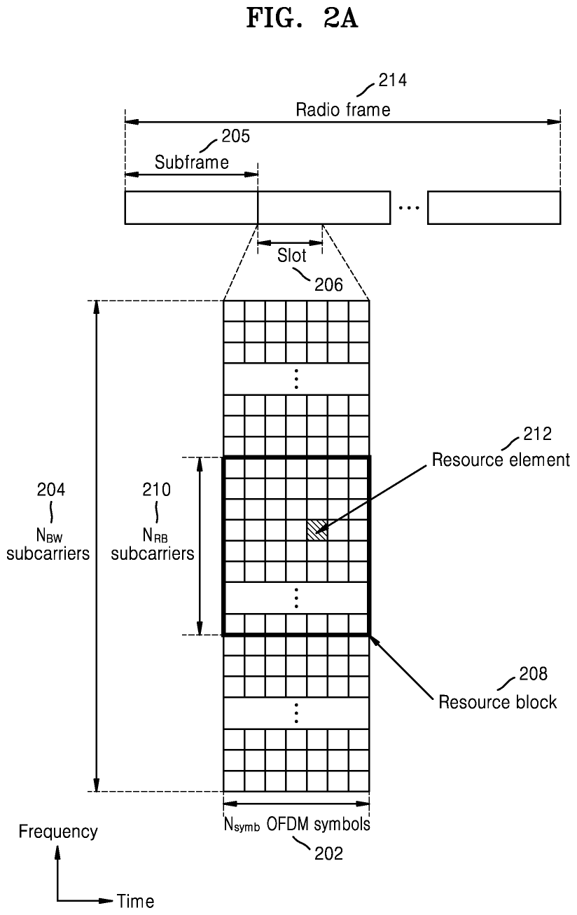

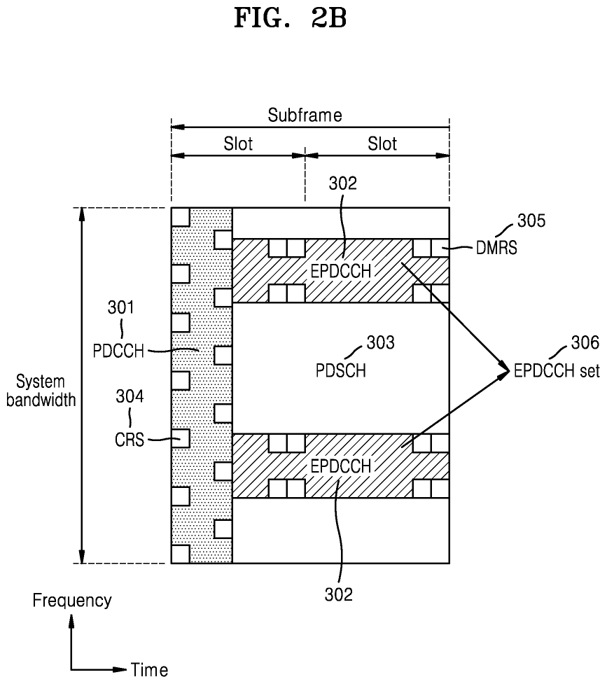

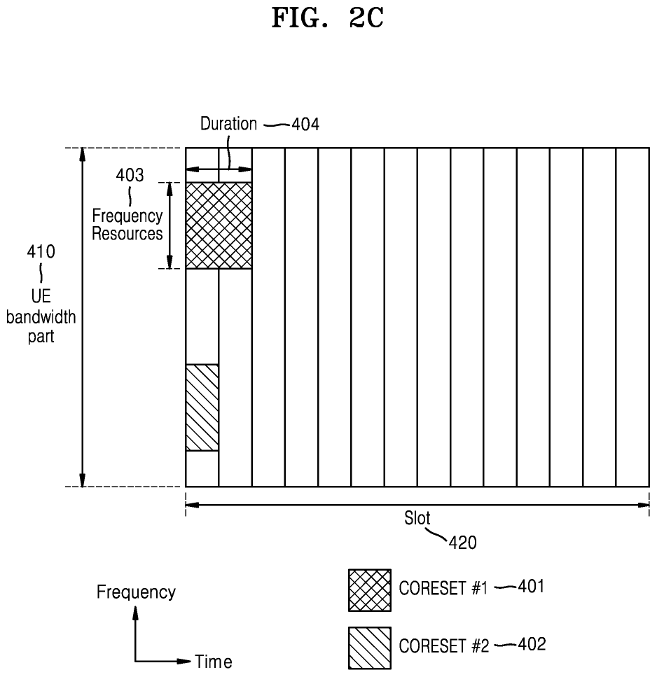

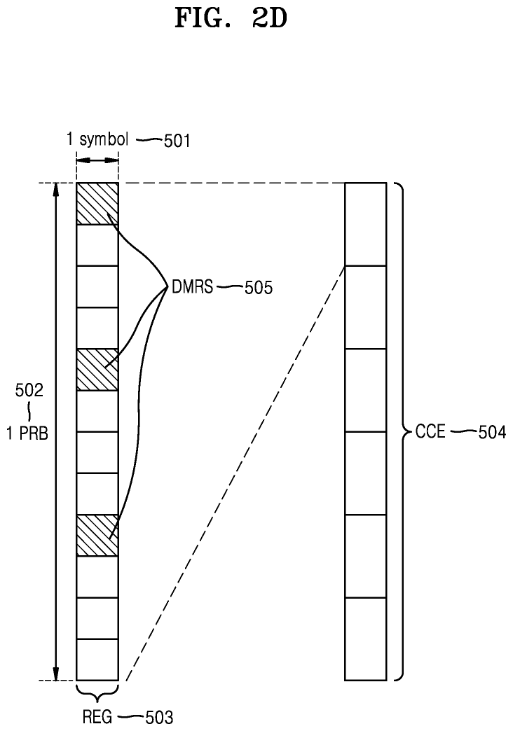

The UE 100 may divide a plurality of CCEs corresponding to one CORESET included in the PDCCH based on the received PDCCH configuration-related information. In some embodiments, the UE 100 may divide the plurality of CCEs by a value corresponding to a largest level from among aggregation levels for the CCEs included in the PDCCH. For example, a largest level from among the aggregation levels may be 16, and the UE 100 may include 16 CCEs into one group. Some embodiments thereof will be described below with reference to FIGS. 2 and 4.

The UE 100 may perform demapping for each divided group, and may perform decoding on the demapped groups. Accordingly, because a demapping operation and a decoding operation may be performed in parallel in units of groups and may be stored in a memory in units of groups, a time and a memory space required for decoding may be effectively reduced compared to when all CCEs allocated to a PDCCH are demapped and all of the demapped CCEs are decoded.

FIG. 2A is a diagram illustrating a basic structure of a time-frequency domain that is a wireless resource region in a wireless communication system, according to an embodiment.

Referring to FIG. 2A, the horizontal axis represents a time domain, and the vertical axis represents a frequency domain. A minimum transmission unit in the time domain is an orthogonal frequency division multiplexing (OFDM) symbol, and N_{symb} OFDM symbols 202 may constitute one slot 206. Two slots may constitute one subframe 205. For example, a length of the slot 206 may be 0.5 ms, and a length of the subframe may be 1.0 ms. However, this is merely an embodiment, and a length of the slot 206 may vary according to a configuration of the slot 206, and the number of slots 206 included in the subframe 205 may vary according to a length of the slot 206. In an NR network, a time-frequency domain may be defined based on the slot 206. Also, a radio frame 214 may be a unit of the time domain unit including 10 subframes 205.

A minimum transmission unit in the frequency domain is a subcarrier, and a bandwidth of an entire system transmission bandwidth may include a total of N_{BW} subcarriers 204. In the time-frequency domain, a basic unit of a resource is a resource element (RE) 212 and may be represented by an OFDM symbol index (value) and a subcarrier index (value). A resource block (RB) 208 may be defined as N_{symb} consecutive OFDM symbols 202 in the time domain and N_{RB} consecutive subcarriers 210 in the frequency domain. Accordingly, one RB 208 may include (N_{symb}*N_{RB}) REs 212. An RB pair is a unit that concatenates two RB s on the time axis and may include (N_{symb}*2N_{RB}) REs 212. A PDCCH may be transmitted from a base station to a UE in a communication system through resources in the time-frequency domain as shown in FIG. 2A, and DCI may be transmitted through the PDCCH. The DCI may include information about downlink scheduling assignment including physical downlink shared channel (PDSCH) resource designation, a transmission format, HARQ information, and spatial multiplexing-related control information.

FIG. 2B is a diagram illustrating a PDCCH and an enhanced PDCCH (EPDCCH) in a wireless communication system supporting LTE, according to an embodiment.

Referring to FIG. 2B, a PDCCH 301 may be time multiplexed with a PDSCH 303, which is a data transmission channel, and may be transmitted over an entire system bandwidth. The PDCCH 301 may be expressed by a number of OFDM symbols, which may be indicated to a UE through a control format indicator (CFI) transmitted through a physical control format indicator channel (PCFICH). The PDCCH 301 may be assigned to an OFDM symbol in the beginning of a subframe, and thus the UE may decode downlink scheduling assignment as quickly as possible. Because one PDCCH may carry one unit of DCI, and a plurality of UEs may be simultaneously scheduled in downlink and uplink, a plurality of PDCCHs may be simultaneously transmitted to each UE.

A CRS 304 is used as a reference signal for decoding the PDCCH 301. The CRS 304 may be transmitted every subframe over an entire band, and scrambling and resource mapping may vary according to an identity (ID) of a base station (or a cell). Because the CRS 304 is a reference signal commonly used by all UEs, UE-specific beamforming may not be used. Accordingly, a multi-antenna transmission method with respect to the PDCCH of LTE is limited to open-loop transmission diversity. The number of ports of the CRS 304 may be implicitly known to the UE from decoding of a physical broadcast channel (PBCH).

Resource allocation of the PDCCH 301 is based on CCE units, where one CCE may include 9 resource element groups (REGs), e.g., a total of 36 REs. The number of CCEs required for the specific PDCCH 301 may be 1, 2, 4, or 8, which varies according to a channel coding rate of a payload of the DCI. As described above, different numbers of CCEs may be used to implement link adaptation of the PDCCH 301.

The UE needs to detect a signal without knowing information about the PDCCH 301, and a search space representing a set of CCEs has been defined for blind decoding. The search space is classified into a UE-specific search space and a common search space. A certain group of UEs or all UEs may examine the common search space of the PDCCH 301 to receive control information common to the base station such as a dynamic scheduling or paging message with respect to system information. For example, scheduling assignment information of a DL-SCH for transmission of a system information block (SIB)-1 including operator information of the base station, etc. may be received by examining the common search space of the PDCCH 301. In addition, the UE-specific DCI, such as scheduling information about uplink data and scheduling information about downlink data, is transmitted in a mode using a UE-specific search space.

Meanwhile, an EPDCCH 302 may be transmitted in a manner frequency multiplexed with the PDSCH 303. The base station may appropriately allocate resources of the EPDCCH 302 and the PDSCH 303 through scheduling, thereby effectively supporting coexistence with data transmission for the UE.

A plurality of EPDCCHs 302 constitute one EPDCCH set 306, and are allocated in units of physical resource block (PRB) pairs. Location information about the EPDCCH set 306 is set UE-specifically, which may be signaled through radio resource control (RRC). Up to two EPDCCH sets 306 may be set for each UE, and one EPDCCH set 306 may be multiplexed to different UEs and set at the same time.

In the EPDCCH 302, a demodulation reference signal (DMRS) 305 is used as an RS for decoding. The DMRS 305 of the EPDCCH 302 uses the same pattern as the PDSCH 303. However, unlike the PDSCH 303, the DMRS 305 in the EPDCCH 302 may support up to four antenna ports. The DMRS 305 of the EPDCCH 302 may be transmitted only in a corresponding PRB through which the EPDCCH 302 is transmitted.

An operation of the UE that performs blind decoding according to an embodiment may be applied to both the PDCCH and the EPDCCH described with reference to FIG. 2B.

FIG. 2C is a diagram illustrating a CORESET in which a PDCCH is transmitted in a wireless communication system supporting NR, according to an embodiment. FIG. 2D is a diagram illustrating a basic unit of time and frequency resources constituting a PDCCH in a wireless communication system supporting NR, according to an embodiment.

In FIG. 2C, a UE bandwidth part 410 is set in a frequency axis, and two CORESETs (CORESET #1 401 and CORESET #2 402) are set within one slot 420 in a time axis. The CORESET #1 401 and CORESET #2 402 may be set in specific frequency resources 403 within the entire UE bandwidth part 410 in the frequency axis. The CORESET #1 401 and CORESET #2 402 may be set to occupy one or more OFDM symbols in the time axis, which may be defined as a control resource set duration 404. Referring to FIG. 2C, the CORESET #1 401 may be set to a control resource set duration corresponding to two symbols, and the CORESET #2 402 may be set to a control resource set duration corresponding to one symbol.

A control resource set in NR may be set by a base station for a UE through higher layer signaling (e.g., system information, master information block (MIB), or RRC signaling). Setting a CORESET for the UE may mean providing information such as an identifier (identity) of the CORESET, a frequency range of the CORESET, and a symbol duration of the CORESET.

Referring to FIG. 2D, a basic unit of time and frequency resources constituting a PDCCH may be referred to as an RE group (REG) 503. The REG 503 may be defined as one OFDM symbol 501 in a time axis and one physical resource block (PRB) 502, e.g., 12 subcarriers, in a frequency axis. A base station may configure a PDCCH allocation unit by concatenating the REGs 503.

As shown in FIG. 2D, when a basic unit to which a PDCCH is allocated in NR is a CCE 504, one CCE 504 may include a plurality of REGs 503. For example, the REG 503 shown in FIG. 2D may include 12 REs, and when one CCE 504 includes 6 REGs 503, one CCE 504 may include 72 REs. When a downlink control region is set, the corresponding region may include a plurality of CCEs 504, and a specific PDCCH may be mapped to one or a plurality of CCEs 504 according to an aggregation level in the control region and then transmitted. The CCEs 504 in the control region are classified by numbers, and in this case, the numbers of the CCEs 504 may be assigned according to a logical mapping method.

The basic unit of the PDCCH shown in FIG. 2D, that is, the REG 503, may include both REs to which DCI is mapped and a region to which a DMRS 505, which is a reference signal for decoding the REs, is mapped. As shown in FIG. 2D, three DMRSs 505 may be transmitted in one REG 503. The number of CCEs used to transmit the PDCCH may be 1, 2, 4, 8, or 16 depending on the aggregation level, and different numbers of CCEs may be used to implement link adaptation of the PDCCH. For example, when the aggregation level is ‘L’, one PDCCH may be transmitted through ‘L’ CCEs.

A parameter of a search space with respect to the PDCCH may be set from the base station to the UE by higher layer signaling (e.g., SIB, MIB, or RRC signaling). For example, the base station may set, to the UE, the number of control channel candidates for each aggregation level, a monitoring period with respect to the search space, a monitoring occasion in a symbol unit within a slot with respect to the search space, a search space type (a common search space or a UE-specific search space), a combination of a DCI format to be monitored in the search space and RNTI, a control region index to be monitored in the search space, etc.

An operation of the UE that performs blind decoding according to an embodiment may be applied to the PDCCH described with reference to FIGS. 2C and 2D.

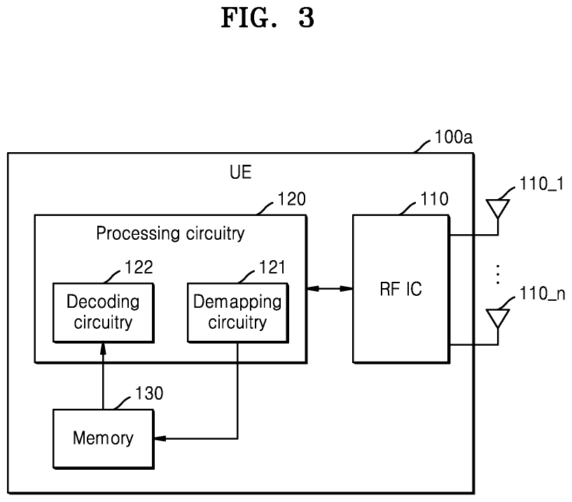

FIG. 3 is a block diagram illustrating a UE, according to an embodiment. In some embodiments, a UE 100a of FIG. 3 may be an example of the UE 100 of FIG. 1, and the same description as that made with reference to FIG. 1 will be omitted. Referring to FIG. 3, the UE 100a may include a radio frequency (RF) integrated circuit 110, a plurality of antennas 110_1 to 110_n, a processing circuit 120, and a memory 130.

The RF integrated circuit 110 may receive RF signals transmitted by the base station 12 through the antennas 110_1 to 110_n. The RF integrated circuit 110 may down-convert the received RF signals to generate intermediate frequency or baseband signals. The processing circuit 120 may generate data signals by filtering, decoding, and digitizing the intermediate frequency or baseband signals. Also, the processing circuit 120 may encode, multiplex, and/or analog-convert the data signals. The RF integrated circuit 110 may frequency up-convert the intermediate frequency or baseband signals output from the processing circuit 120 and may transmit them as RF signals through the antennas 110_1 to 110_n. In some embodiments, the RF integrated circuit 110 may receive a PDCCH including a plurality of CCEs corresponding to one CORESET and PDCCH configuration-related information from the base station 12 of FIG. 1 through the antennas 110_1 to 110_n, and may transmit them to the processing circuit 120.

The processing circuit 120 may determine a “division value” corresponding to the number of CCEs in a largest group of CCEs within one CORESET (divided into groups of CCEs), based on the PDCCH configuration-related information. In some embodiments, the PDCCH configuration-related information may include aggregation levels of the plurality of CCEs included in the PDCCH, and the aggregation levels of the CCEs may be received through RRC signaling with the base station 12 of FIG. 1. The processing circuit 120 may determine a division value based on the aggregation levels of the plurality of CCEs. For example, the aggregation levels of the plurality of CCEs may be 1, 2, 4, 8, and 16, and the processing circuit 120 may determine a division value of 16, corresponding to an aggregation level of 16, which is a largest aggregation level from among the aggregation levels. Thus, in some embodiments, the “division value” equals the corresponding aggregation level.

The processing circuit 120 may divide the plurality of CCEs (or a plurality of CCEs included in a search space) into a plurality of groups based on the division value. For example, the processing circuit 120 may receive the aggregation levels of the CCEs included in the PDCCH and the number of CCEs allocated to the PDCCH. A largest level from among the aggregation levels may be 16, and the number of the allocated CCEs may be 56. When a largest value from among the aggregation levels is 16, a division value may be 16, and the processing circuit 120 may divide the 56 CCEs into 4 groups comprising three units of 16 CCEs and one unit of eight CCEs. Some embodiments thereof will be described below with reference to FIG. 4.

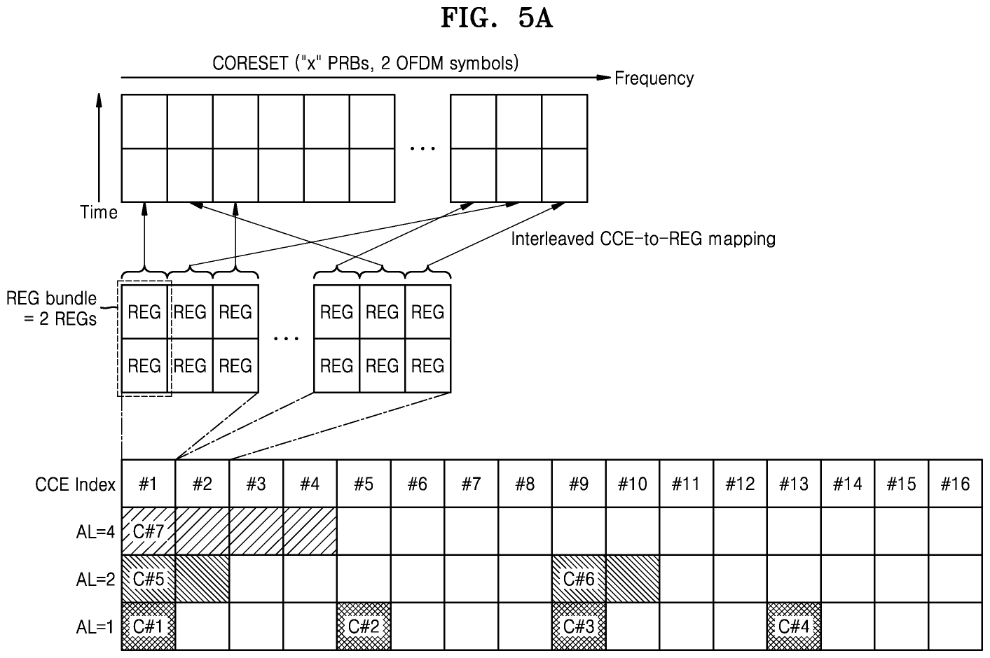

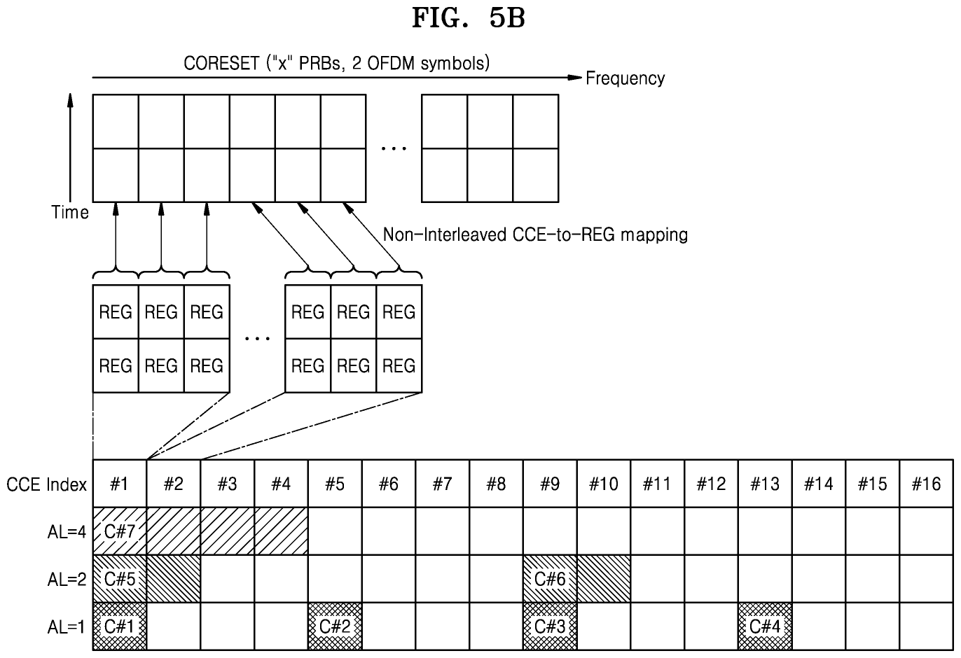

The processing circuit 120 may include a demapping circuit 121 and a decoding circuit 122. The demapping circuit 121 may demap a plurality of groups divided based on the division value. There may be CCE to RE mapping, hereafter exemplified as CCE-to-REG mapping, for each CORESET, and demapping may refer to a reverse process of a mapping process on CCE-to-REG mapped CCEs in the search space. Some embodiments of a CCE-to-REG mapping operation and some embodiments of a demapping operation will be described below with reference to FIGS. 5A and 5B.

In some embodiments, the demapping circuit 121 may sequentially perform a demapping operation for each group on a plurality of groups. For example, the plurality of groups may include first to N^{th} groups, and the demapping circuit 121 may perform a demapping operation on the first group and then may perform a demapping operation on the second group.

The decoding circuit 122 may decode the demapped plurality of groups. In some embodiments, the decoding circuit 122 may perform blind decoding on PDCCH candidates including CCEs included in the first group from among the demapped plurality of groups.

In some embodiments, the decoding circuit 122 may be configured to perform a decoding operation for each group on the demapped groups in an order in which demapping operations are completed. For example, the decoding circuit 122 may blind-decode the demapped first group, and the demapping circuit 121 may demap the second group in parallel thereto. After the demapping of the second group is completed, the decoding circuit 122 may blind-decode the demapped second group, and the demapping circuit 121 may demap the third group in parallel thereto.

The processing circuit 120 may divide the plurality of CCEs included in the PDCCH (or the plurality of CCEs included in the search space) into a plurality of groups based on the division value, and may perform demapping and decoding operations for each group in parallel. Accordingly, a time required for decoding may be effectively reduced compared to when all of the CCEs allocated to the PDCCH are demapped and all of the demapped CCEs are decoded.

The memory 130 may store data for a decoding operation for each group performed by the processing circuit 120. A plurality of groups demapped by the demapping circuit 121 may be stored in the memory 130, and the stored demapped plurality of groups may be referred to as data for a decoding operation for each group. The demapping circuit 121 may transmit the demapped first group to the memory 130, and the memory 130 may store the demapped first group. Next, the demapping circuit 121 may transmit the demapped second group to the memory 130, and the memory 130 may delete the demapped first group to store the demapped second group. For example, the memory 130 may delete the demapped first group by overwriting the demapped first group with the demapped second group to store the demapped second group.

The memory 130 may have a capacity based on a maximum value of the division value determined by the processing circuit 120. For example, when a maximum value of the division value is 16, each of the plurality of groups may include up to 16 CCEs, and the memory 130 may store LLRs corresponding to the 16 CCEs. In contrast, when all of the CCEs allocated to the PDCCH are demapped, the total number of CCEs may be 56, and the memory 130 may store LLRs corresponding to the 56 CCEs. Accordingly, when the UE 100a performs demapping and decoding for each group, a memory space required for decoding may be effectively reduced.

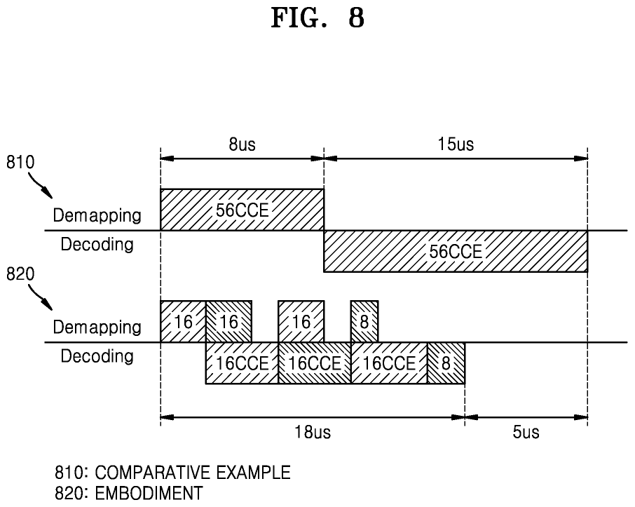

The processing circuit 120 may perform a quick sleep (QS) function. The QS function may refer to a function of turning off power of the UE when it is determined that there is no valid DCI based on a result of performing decoding on the PDCCH including the plurality of CCEs corresponding to one CORESET. In some embodiments, a time required when the UE 100a divides the PDCCH into a plurality of groups and performs demapping and decoding may be shorter than a time required when the UE 100a demaps and decodes the entire PDCCH. Accordingly, because the QS function may be quickly executed, power consumption of the UE 100a may be effectively reduced. Some embodiments thereof will be described below with reference to FIG. 8.

FIG. 4 is a diagram for describing an operation of determining a division value based on an aggregation level of a UE, according to an embodiment.

Referring to FIGS. 1 and 4, FIG. 4 is a diagram illustrating a location where a PDCCH candidate may exist. In some embodiments, the total number of CCEs allocated to a PDCCH may be 56, and aggregation levels of the CCEs may be 1, 2, 4, 8, and 16. Referring to Equation 1 described with reference to FIG. 1, because the aggregation level L is calculated as outermost multiplication, “start CCEs” of all PDCCH candidates may exist as multiples of the aggregation level L. For example, in FIG. 4, start CCEs for CCE groups corresponding to aggregation level 16 (“AL16) are CCE #0 (”CCE index 0″), CCE #16, CCE #32 and CCE #48. Accordingly, when the UE 100 of FIG. 1 determines a value corresponding to a largest level from among aggregation levels of CCEs included in PDCCH configuration-related information, one PDCCH candidate may have a smaller number of CCEs than the other groups. For instance, in association with AL16, a fourth group with start CCE #48 may have a smaller number of CCEs than first, second and third groups with start CCEs CCE #0, CCE #16 and CCE #32, respectively. Each of groups formed based on a division value may be demapped and decoded for each group without data loss.

In some embodiments, a largest level of aggregation levels may be 16, and the UE 100 of FIG. 1 may group 16 CCEs into one group. A first group may include CCE index 0 to CCE index 15, a second group may include CCE index 16 to CCE index 31, and a third group may include CCE index 32 to CCE index 47. A largest level from among aggregation levels of CCEs that are not grouped into the largest CCE groups (e.g., 16 CCEs) may be 8, such that the UE 100 of FIG. 1 may group remaining CCEs (8 CCEs) into one group. Thus, a fourth group may have eight CCEs, which may be CCE index 48 to CCE index 55.

In some embodiments, unlike the example of FIG. 4, when a largest level of aggregation levels is four, the UE 100 of FIG. 1 may group four CCEs into one group. Because a division value may be adaptively determined based on a largest value of aggregation levels, a time required for decoding may be effectively reduced.

FIGS. 5A and 5B are diagrams for describing a demapping operation of a UE, according to an embodiment.

Referring to FIG. 3, the demapping circuit 121 may demap a plurality of groups divided based on a division value. There may be CCE-to-REG mapping for each CORESET, and demapping may refer to a reverse process of a mapping process on CCE-to-REG mapped CCEs in a search space. The term “REG bundling” may be used for CCE-to-REG mapping, and there may be interleaving and non-interleaving methods. In some embodiments, one CCE may include a plurality of REGs, and one REG may include a plurality of REs. REG bundling may mean how many REGs constitute one CCE. For example, when an REG bundle size is 6, 6 REGs may constitute one CCE, and when an REG bundle size is 2, 2 REGs may constitute one CCE.

Referring further to FIG. 5A, a CORESET may include “x” PRBs (“x” is an integer) in a frequency domain, and may include 2 OFDM symbols in a time domain. In detail, the CORESET may include a plurality of resource element groups (REGs), and two REGs may constitute one REG bundle. For example, an REG may include 12 REs in the frequency domain, and may include one OFDM symbol in the time domain. A control channel element (CCE) may include 6 REGs. REGs included in CCEs (#1 to #16) may be mapped in an interleaving method. An interleaving method may refer to a method of forming one CCE with non-consecutive REGs.

An aggregation level AL may indicate the number of CCEs allocated for a PDCCH. Also, the number of candidates may vary according to the aggregation level. For example, when the aggregation level AL is 1, the first CCE #1, the fifth CCE #5, the ninth CCE #9, and the 13^{th} CCE #13 may respectively correspond to first to fourth candidates C #1, C #2, C #3, and C #4. When the aggregation level AL is 2, the first CCE #1 and the second CCE #2 may correspond to a fifth candidate C #5, and the ninth CCE #9 and the tenth CCE #10 may correspond to a sixth candidate C #6. When the aggregation level AL is 4, the first CCE #1, the second CCE #2, the third CCE #3, and the fourth CCE #4 may correspond to a seventh candidate C #7.

In some examples, the processing circuit 120 may determine that the division value is four (where four may correspond to a largest value from among aggregation levels) and may group the first to fourth CCEs into a first group. The demapping circuit 121 may perform interleaving on the first group in reverse order, and may divide an REG bundle into 2 REGs. A demapping process may refer to an operation performed by the demapping circuit 121 on the first group.

Referring to FIG. 5B, unlike in FIG. 5A, three REG bundles included in the CCEs (#1 to #16) may be mapped in a non-interleaving method. A non-interleaving method may refer to a method of forming one CCE with consecutive REGs.

In some examples, the processing circuit 120 may determine that the division value is four (where four may correspond to a largest level from among aggregation levels) and may group the first CCE to the fourth CCE into a first group. The demapping circuit 121 may divide an REG bundle into 2 REGs. A demapping operation may refer to an operation performed by the demapping circuit 121 on the first group.

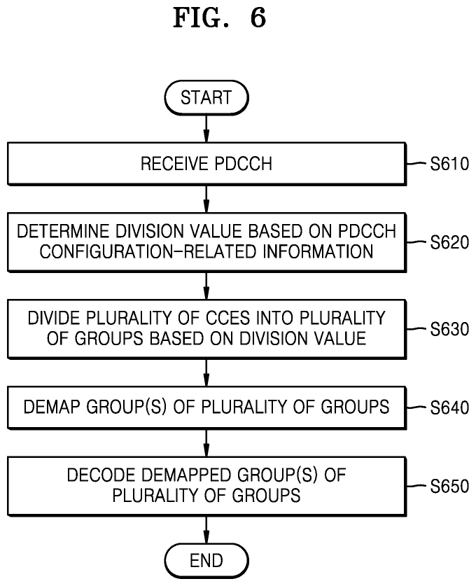

FIG. 6 is a flowchart illustrating an operating method of a UE, according to an embodiment. As shown in FIG. 6, an operating method of a UE may include a plurality of operations S610 to S650.

In operation S610, the UE 100a may receive a PDCCH. In some embodiments, the UE 100a may receive the PDCCH including downlink control information (DCI) from the base station 12. The PDCCH may include a plurality of control channel elements (CCEs) corresponding to one CORESET.

In operation S620, the processing circuit 120 may determine a division value based on PDCCH configuration-related information. In some embodiments, the PDCCH configuration-related information may include aggregation levels of the plurality of CCEs included in the PDCCH, and the aggregation levels of the CCEs may be received through RRC signaling with the base station 12 of FIG. 1. The processing circuit 120 may determine a division value based on the aggregation levels of the plurality of CCEs. For example, the aggregation levels of the plurality of CCEs may be 1, 2, 4, 8, and 16, and the processing circuit 120 may determine a value corresponding to 16 that is a largest level from among the aggregation levels, that is, 16, as a division value.

In operation S630, the processing circuit 120 may divide the plurality of CCEs into a plurality of groups based on the division value. For example, the processing circuit 120 may receive the aggregation levels of the CCEs included in the PDCCH and the number of CCEs allocated to the PDCCH. In an example, a largest level from among the aggregation levels may be 16, and the number of the allocated CCEs may be 56 (as shown in FIG. 4). When a largest value from among the aggregation levels is 16, a division value may be 16, and the processing circuit 120 may divide the 56 CCEs into four groups: three groups in units of 16 CCEs and one group of eight CCEs, as illustrated in FIG. 4.

In operation S640, the demapping circuit 121 may demap at least one group of the plurality of groups, one group at a time. (If subsequent decoding in operation S650 succeeds on any group, demapping may be omitted on any remaining groups.) In an example, in a first group from among the plurality of groups, when an REG bundle includes 6 REGs and a mapping method is an interleaving method, the demapping circuit 121 may perform interleaving on the first group in reverse order and may divide the REG bundle into 6 REGs.

In some embodiments, the demapping circuit 121 may sequentially perform a demapping operation for each group of the plurality of groups. For example, the plurality of groups may include first to N^{th} groups, and the demapping circuit 121 may perform a demapping operation on the first group and then perform a demapping operation on the second group.

In operation S650, the decoding circuit 122 may decode the demapped group(s) of the plurality of groups. For example, the decoding circuit 122 may begin operation S650 by performing blind decoding on PDCCH candidates including CCEs of the first demapped group.

In some embodiments, the decoding circuit 122 may be configured to perform a decoding operation for each group of the demapped groups in an order in which demapping operations are completed. For example, the decoding circuit 122 may blind-decode the demapped first group, and the demapping circuit 121 may demap the second group in parallel thereto (concurrently). After the demapping of the second group is completed, the decoding circuit 122 may blind-decode the demapped second group, and the demapping circuit 121 may demap the third group in parallel thereto. With this approach, the total processing time for demapping and decoding CCE groups until a successful decoding for any CCE group is achieved may be reduced as compared to conventional methods that demap undivided CORESETS and/or demap and decode all CCEs under consideration in mutually exclusive time periods.

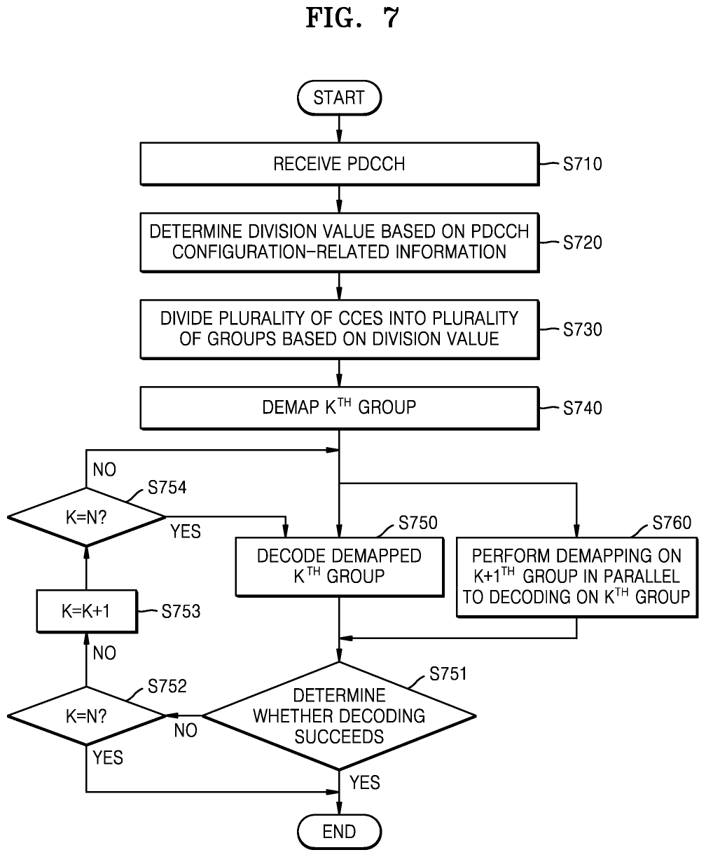

FIG. 7 is a flowchart illustrating an operating method of a UE, according to an embodiment. As shown in FIG. 7, an operating method of a UE may include a plurality of operations S710 to S760. Operations S710 to S730 may be the same as operations S610 to S630 of FIG. 7, and therefore redundant descriptions thereof may be omitted.

In operation S740, the demapping circuit 121 (FIG. 3) may demap a K^{th} group (where K is an integer that may be initially set to “1”). In operation S730, the processing circuit 120 may divide a plurality of CCEs into first to N^{th} groups, and the demapping circuit 121 may demap the K^{th} group that is one of the first to N^{th} groups. For example, the demapping circuit 121 may demap the first group.

In operation S750, the decoding circuit 122 may decode the demapped K^{th} group. In operation S760, the demapping circuit 121 may perform demapping on the (K+1)^{th}group in parallel to (concurrently with) the decoding on the demapped K^{th} group by the decoding circuit 122. For example, the decoding circuit 122 may perform decoding on the demapped first group, and the demapping circuit 121 may perform demapping on the second group in parallel to the decoding on the first group.

In operation S751, the processing circuit 120 may determine whether the decoding on the k^{th} group succeeds. In some embodiments, when the decoding on the K^{th} group succeeds, a decoding operation and a demapping operation may be omitted. For example, the processing circuit 120 may perform decoding on the first group, and when the decoding succeeds, the processing circuit 120 may omit decoding on the second group and may omit demapping on the third group. When the decoding on the K^{th} group succeeds, it may mean that valid DCI is obtained as a result of the decoding on the K^{th} group. For example, when a cyclic redundancy check (CRC) passes in a result of the decoding on the first group, the processing circuit 120 may determine that the decoding of the first group succeeds.

Because demapping or decoding may be omitted when valid DCI is obtained, a time required for decoding may be effectively reduced compared to when all CCEs allocated to a PDCCH are demapped and all of the demapped CCEs are decoded.

In some embodiments, when the decoding on the K^{th} group fails in operation S751, operation S752 may be performed. In operation S752, the processing circuit 120 may determine whether the K^{th} group is the N^{th} group. The processing circuit 120 may sequentially demap and decode the plurality of groups, and the N^{th} group may be a last group from among the plurality of groups. When the K^{th} group is the N^{th} group, because the received PDCCH has been completely demapped and decoded, a subsequent operation may be omitted. For example, the processing circuit 120 may divide the plurality of CCEs into first to fourth groups, and the K^{th} group may be the fourth group. Because the K^{th} group is the fourth group that is the N^{th} group, the processing circuit 120 may omit subsequent decoding and demapping operations.

In some embodiments, when the Kk^{th} group is not the N^{th} group, operations S753 and S754 may be performed. In operations S753 and S754, the processing circuit 120 may determine whether the (K+1)^{th} group that is a next group of the K^{th} group is the N^{th} group to sequentially perform demapping and decoding on the plurality of groups. When the (K+1)^{th} group is the N^{th} group, the (K+1)^{th} group may be a last group. Because demapping on the (K+1)^{th} group has been performed in parallel to the decoding on the K^{th} group in operation S760 and there is no group after the (K+1)^{th} group, the decoding circuit 122 may perform decoding on the (K+1)^{th} group in operation S750. For example, the processing circuit 120 may divide the plurality of CCEs into first to fourth groups, and the K^{th} group may be the third group. Because demapping on the fourth group (the (K+1)^{th} group) has been performed in parallel to the decoding on the third group in operation S760 and there is no fifth group, the decoding circuit 122 may perform decoding on the fourth group in operation S750.

In some embodiments, when the (K+1)^{th} group is not the N^{th} group, the (K+1)^{th} group may not be a last group. The decoding circuit 122 may perform decoding on the (K+1)^{th} group in operation S750, and the demapping circuit 121 may perform demapping on the (K+2)^{th} group in operation S760 in parallel to operation S750. For example, the processing circuit 120 may divide the plurality of CCEs into first to fourth groups, and the K^{th} group may be the first group. The decoding circuit 122 may perform decoding on the second group in operation S750, and the demapping circuit 121 may perform demapping on the third group in operation S760 in parallel to operation S750.

FIG. 8 is a graph showing a time required for a demapping operation and a decoding operation of a UE according to a comparative example and a time required for a demapping operation and a decoding operation of a UE according to an embodiment of the inventive concept. Although the total number of CCEs allocated to a PDCCH is 56 in a first graph 810 and a second graph 820, the technical idea of the inventive concept is not limited thereto.

Referring to FIGS. 3 and 8, the first graph 810 may be a graph showing a time required when the UE performs blind decoding without dividing all of the CCEs allocated to the PDCCH according to the comparative example. In some embodiments, the UE may first perform a demapping operation on all of the CCEs, and a time required for the demapping operation may be 8 us. Next, the UE may perform a decoding operation on all of the demapped CCEs, and a time required for the decoding operation may be 15 us, and thus, a time required to perform blind decoding may be 23 us.

The second graph 820 may be a graph showing a time required when the UE divides all of the CCEs allocated to the PDCCH based on aggregation levels of the CCEs and performs blind decoding for each group. In some embodiments, the UE 100a may determine a division value corresponding to 16 that is a largest value from among the aggregation levels to be 16. Accordingly, the UE 100a may divide all of the CCEs into first to third groups each including 16 CCEs and a fourth group including 8 CCEs. The UE 100a may demap the first group and may decode the demapped first group. The UE 100a may demap the second group in parallel to the decoding on the demapped first group. Accordingly, a time required to perform blind decoding on the first to fourth groups may be 18 us.

The UE may perform a QS function, and the UE of the comparative example may perform a QS function after up to 23 us whereas the UE 100a of Embodiment may perform a QS function after up to 18 us. Accordingly, because the UE 100a according to Embodiment may quickly perform a QS function, power consumption of the UE 100a may be effectively reduced.

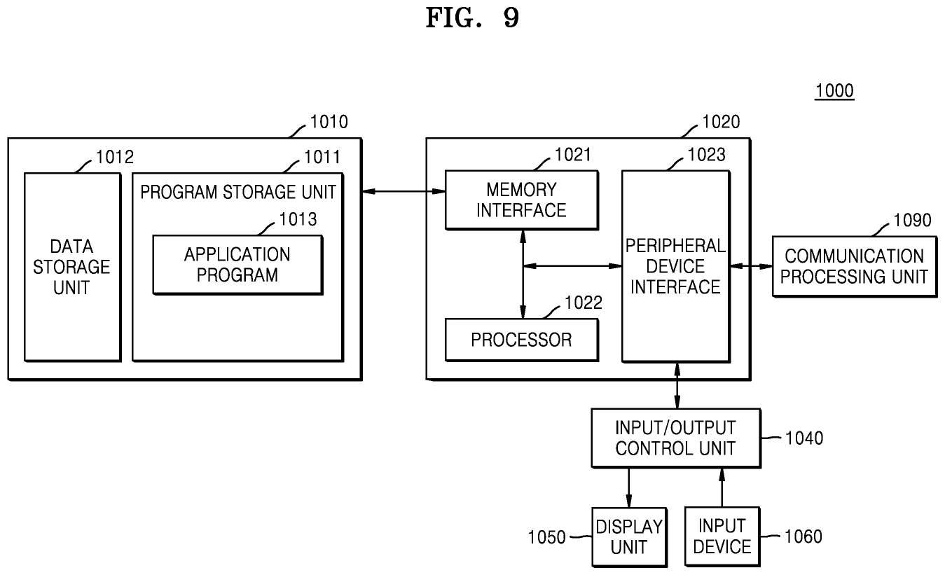

FIG. 9 is a block diagram illustrating an electronic device, according to an embodiment.

Referring to FIG. 9, an electronic device 1000 may include a memory 1010, a processor unit 1020, an input/output control unit 1040, a display unit 1050, an input device 1060, and a communication processing unit 1090. The electronic device 1000 may include a plurality of memories 1010. Each element is as follows.

The memory 1010 may include a program storage unit 1011 that stores a program for controlling an operation of the electronic device 1000, and a data storage unit 1012 that stores data generated during execution of the program. The data storage unit 1012 may store data required for an operation of an application program 1013 and a data demodulation program 1014, or may store data generated from an operation of the application program 1013 and the data demodulation program 1014.

The program storage unit 1011 may include the application program 1013. The program included in the program storage unit 1011 may be expressed as an instruction set. The application program 1013 may include program codes for executing various applications operating in the electronic device 1000. That is, the application program 1013 may include codes (or commands) related to various applications driven by a processor 1022.

The electronic device 1000 may include the communication processing unit 1090 that performs a communication function for voice communication and data communication. A peripheral device interface 1023 may control connection between the input/output control unit 1040, the communication processing unit 1090, the processor 1022, and a memory interface 1021. The processor 1022 controls a plurality of base stations to provide corresponding services using at least one software program. In this case, the processor 1022 may execute at least one program stored in the memory 1010 to provide a service corresponding to the program. The electronic device 1000 may perform an operating method of a UE that divides a PDCCH based on PDCCH configuration-related information and performs blind decoding described with reference to FIGS. 1 to 8.

The input/output control unit 1040 may provide an interface between an input/output device, such as the display unit 1050 and the input device 1060, and the peripheral device interface 1023. The display unit 1050 displays state information, input characters, moving pictures, still pictures, etc. For example, the display unit 1050 may display application program information driven by the processor 1022.

The input device 1060 may provide input data generated by selection of the electronic device to the processor unit 1020 through the input/output control unit 1040. In this case, the input device 1060 may include a keypad including at least one hardware button and a touch pad for sensing touch information. For example, the input device 1060 may provide touch information, such as a touch, a touch movement, and a touch release, sensed through the touch pad, to the processor 1022 through the input/output control unit 1040.

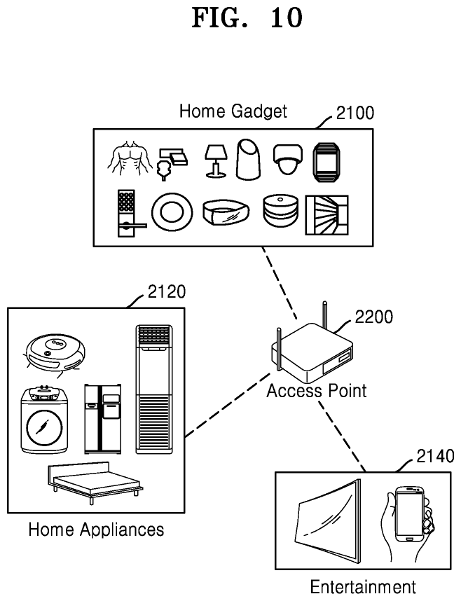

FIG. 10 is a conceptual diagram illustrating an Internet of things (IoT) network system to which an embodiment is applied.

Referring to FIG. 10, an IoT network system 2000 may include a plurality of IoT devices 2100, 2120, 2140, and 2160, an access point 2200, a gateway 2250, a wireless network 2300, and a server 2400. The IoT may refer to a network between objects using wired/wireless communication.

Each of the IoT devices 2100, 2120, 2140, and 2160 may form a group according to characteristics of each IoT device. For example, the IoT devices may be grouped into a home gadget group 2100, a home appliance/furniture group 2120, an entertainment group 2140, or a vehicle group 2160. The plurality of IoT devices 2100, 2120, and 2140 may be connected to a communication network or may be connected to other IoT devices through the access point 2200. The access point 2200 may be provided in one IoT device. The gateway 2250 may change a protocol to connect the access point 2200 to an external wireless network. The IoT devices 2100, 2120, and 2140 may be connected to an external communication network through the gateway 2250. The wireless network 2300 may include the Internet and/or a public network. The plurality of IoT devices 2100, 2120, 2140, and 2160 may be connected to the server 2400 that provides a certain service through the wireless network 2300, and a user may use a service through at least one of the plurality of IoT devices 2100, 2120, 2140, and 2160. The plurality of IoT devices 2100, 2120, 2140, and 2160 may perform an operating method of a UE that divides a PDCCH based on PDCCH configuration-related information and performs blind decoding described with reference to FIGS. 1 to 8.

In embodiments described above, a hardware approach is described as an example. However, because embodiments include technology using both hardware and software, embodiments do not exclude a software-based approach.

Various functions described above may be implemented or supported by artificial intelligence technology or one or more computer programs, each of which includes computer-readable program code and is implemented in a computer-readable medium. The terms “application” and “program” refer to one or more computer programs, software components, sets of instructions, procedures, functions, objects, classes, instances, associated data, or portions thereof suitable for implementation of suitable computer-readable program code. The term “computer-readable program code” includes any type of computer code, including source code, object code, and executable code. The term “computer-readable medium” includes any type of medium capable of being accessed by a computer, such as a read-only memory (ROM), a random-access memory (RAM), a hard disk drive, a compact disc (CD), a digital video disc (DVD), or any other type of memory. “Non-transitory” computer-readable media exclude wired, wireless, optical, or other communication links that transmit transitory electrical or other signals. The non-transitory computer-readable media include media in which data may be permanently stored, and media in which data may be stored and later overwritten, such as a rewritable optical disk or a removable memory device.

Embodiments have been described with reference to the drawings and the specification. While embodiments have been described by using specific terms, the terms have merely been used to explain the technical idea of the inventive concept and should not be construed as limiting the scope of the inventive concept defined by the claims. Hence, it will be understood by one of ordinary skill in the art that various modifications may be made therefrom to realize other embodiments. Accordingly, the technical scope of the inventive concept should be defined by the following claims.

What is claimed is:

1. An operating method of a user equipment, the operating method comprising:
receiving a physical downlink control channel (PDCCH) comprising a plurality of control channel elements (CCEs) corresponding to one control resource set;
determining a division value corresponding to a number of CCEs to be included in at least a first group of a plurality N of groups of CCEs, based on PDCCH configuration-related information;
dividing the plurality of CCEs into the N groups based on the division value;
performing CCE to resource element (RE) demapping on the first group; and
decoding the demapped first group.

2. The operating method of claim 1, further comprising receiving the PDCCH configuration-related information through radio resource control (RRC) signaling with a base station.

3. The operating method of claim 2, wherein the PDCCH configuration-related information comprises aggregation levels of the CCEs, a number of candidates, and a number of the plurality of CCEs,
wherein the division value is a value determined by the user equipment based on the aggregation levels of the CCEs.

4. The operating method of claim 3, wherein the division value corresponds to a largest level from among the aggregation levels of the CCEs.

5. The operating method of claim 1, further comprising performing CCE to RE demapping on a second group included in the N groups,
wherein the CCE to RE demapping on the second group is performed concurrently with the decoding of the demapped first group.

6. The operating method of claim 5, wherein, when the decoding of the demapped first group succeeds, decoding of the demapped second group is omitted.

7. The operating method of claim 5, wherein, when the decoding of the demapped first group succeeds, demapping of groups other than the first group and the second group from among the N groups is omitted.

8. The operating method of claim 1, wherein the decoding of the demapped first group comprises performing blind decoding on PDCCH candidates comprising CCEs in the demapped first group.

9. The operating method of claim 1, wherein a memory used in the decoding of the demapped first group has a capacity based on a maximum value of the division value.

10. The operating method of claim 9, further comprising, when the decoding of the demapped first group fails, deleting decoding-related data stored during decoding the demapped first group from the memory.

11. The operating method of claim 10, wherein the deleting of the stored decoding-related data comprises overwriting the stored data with decoding-related data stored during decoding a demapped second group included in the N groups.

12. The operating method of claim 1, further comprising, when decoding of all of the N groups fails, performing a quick sleep (QS) function.

13. An operating method of a user equipment for performing blind decoding, the operating method comprising:
receiving a physical downlink control channel (PDCCH) comprising a plurality of control channel elements (CCEs) corresponding to one control resource set, and PDCCH configuration-related information;
determining a division value corresponding to a number of CCEs to be included in each of a plurality of groups of CCEs based on the PDCCH configuration-related information;
dividing the plurality of CCEs into first to N^{th} groups based on the division value, where N is a natural number of two or more;
performing demapping on the first group; and
performing blind decoding on the demapped first group and demapping on the second group in parallel.

14. The operating method of claim 13, wherein the PDCCH configuration-related information comprises aggregation levels of the CCEs, a number of candidates, and a number of the plurality of CCEs,
wherein the division value is a largest value from among the aggregation levels of the CCEs,
wherein the dividing of the plurality of CCEs into the first to N^{th} groups further comprises dividing the plurality of CCEs in units of the largest value from among the aggregation levels.

15. The operating method of claim 13, wherein, when decoding succeeds in the performing of the blind decoding on the demapped first group demapping of groups other than the first group and the second group from among the N groups is omitted.

16. A user equipment comprising:
a radio frequency (RF) integrated circuit configured to receive, from a base station, a physical downlink control channel (PDCCH) comprising a plurality of control channel elements (CCEs) and PDCCH configuration-related information; and
a processing circuit configured to determine a division value based on the PDCCH configuration-related information, divide the plurality of CCEs into a plurality of groups based on the division value, sequentially perform demapping operations on the plurality of groups on a group by group basis, and perform decoding operations on the plurality of groups on a group by group basis in an order in which demapping operations are completed.

17. The user equipment of claim 16, further comprising a memory used to perform a decoding operation for each group of the plurality of groups,
wherein the memory has a capacity based on a maximum value of the division value.

18. The user equipment of claim 16, wherein the demapping operations for some of the groups are performed in parallel to the decoding operations for some of the groups.

19. The user equipment of claim 16, wherein the PDCCH configuration-related information comprises aggregation levels of the CCEs, a number of candidates, and a number of the plurality of CCEs,
wherein the division value is a largest value from among the aggregation levels of the CCEs.

20. The user equipment of claim 16, wherein, when a decoding operation for any of the groups succeeds during the performing of the decoding operations, a decoding operation on groups on which a decoding operation for each group has not been performed is omitted.
